(19) United States
(12) Patent Application Publication
(10) Pub. No.: US 2010/0096490 A1
(43) Pub. Date: Apr. 22, 2010

(54) Remote engine/electric helicopter industrial plat form

(76) Inventor: Kevin Patrick Gordon, Santa Clara, CA (US)

Correspondence Address: Kevin Patrick Gordon, 4609 Snead Drive, Santa Clara, CA, 95054, US

(21) Appl. No.: 12/288,307

(22) Filed: Oct. 18, 2008

(51) Int. Cl. B64C 27/04; B64C 1/06; B64C 1/08; B64C 37/02; G05D 1/00; B64C 19/00; B64C 17/00

(52) U.S. Cl. 244/2; 244/121; 244/17.11; 244/17.19; 244/118.5; 701/2; 244/75.1; 244/93

(57) ABSTRACT

The invention is an unmanned flying helicopter aircraft platform (“aircraft platform”) that can be powered by either interchangeable electric motors or by fuel powered internal combustion engines. The aircraft platform is surrounded by a lightweight exoskeleton cage that protects the rotor blades from coming into contact with external objects. The aircraft platform uses a weight located on the bottom side of the aircraft platform that can be remotely moved to adjust the center of gravity in order to navigate in any direction. The aircraft platform has a place on its bottom side where attachments can be added or removed which allows the aircraft platform to be used for multiple different purposes. The aircraft platform can be flown and operated either remotely using a hand held control unit or it can be flown and operated by an onboard pilot located in the human carrying attachment.

### BACKGROUND AND SUMMARY OF THE INVENTION

The purpose of the invention is to use a flying helicopter platform, also known as “the aircraft” or other similar names that can act as a flying crane that can lift and transport heavy loads or can carry attachments that can fight fires, perform surveillance activities, or that can carry people, among many other things. The aircraft flies by using a platform that is circular on the sides and which is flat on the top and bottom, similar to two dinner plates placed horizontally and connected by multiple vertical column, rods, or tubes which provide for sufficient space between the top and bottom circular pieces to contain two counter rotating helicopter blades, motors, engines, computers and other items needed. It has a diameter of multiple feet across in order to make it of a sufficient size to contain large enough counter rotating helicopter rotor blades to lift a significant amount of weight.

It is powered by four internal combustion engines, or four electric motors, depending on which is desired. The engines or motors work as one unit and are attached to a vertical rotor shaft that is attached to two horizontal counter rotating helicopter rotor blades that are above the engines or electric motors, depending on which is being used, and shaft. The helicopter platforms engines can be easily interchanged or replaced with electric motors, or vise versa. The two horizontal counter rotating helicopter rotor blades are powered by four engines or motors working together through one gear box or transmission. The four engines or motors fit together similar to four equal quarter size pieces of a circle or of a pie. This provides for redundancy as the flying helicopter crane platform can land under control with only three engines or motors working. By using the thrust created by the counter rotating helicopter rotor blades the aircraft is lifted into the air and flies. Each aircraft has all of the wires, fuel pumps, fuel lines, and other necessary items to operate engines or electric motors for powering the counter rotating helicopter rotor blades. The engines and fuel tanks are interchangeable with the electric motors and batteries and vice versa.

There is a conveyer belt type system that is run by electric motors and which is located on or near the bottom of the aircraft that has a large weight attached to it. When the weight is located in the exact center of gravity of the aircraft it causes it to hover. When the conveyer belt is moved forward or backward by the electric motors it causes the weight to move forward or backward with the conveyer belt that it is attached to. This causes the aircraft to tilt forward or backward in varying degrees depending on how far forward or backward the weight on the conveyer belt is moved. When the aircraft tilts forward or backward then the angle of the helicopter's counter rotating rotor blades are also tilted forward or background. This causes the angle of the thrust from the rotor blades to change and to propel the aircraft forward or backward at different speeds. The steeper the angle of the aircraft, the faster the aircraft is propelled. This angle can be carefully controlled by moving the weight slower or faster as needed. The aircraft can turn left or right by accelerating one counter rotating blade faster than the other. The increased centripetal force and momentum produced by one counter rotating rotor blade over the other causes the aircraft to turn in that direction and vice versa.

There is an attachment that can be placed on the top or the bottom of the aircraft that contains two vertical parallel airplane propellers that act in conjunction to propel the aircraft forward at a faster speed than can be produced by the conveyer belt and heavy weight that causes the angle of the aircraft to angle forward and backward. These airplane propellers can be powered by either engines or electric motors. The engines or electric motors can be detached and interchanged with each other. When the engines' or electric motors' direction are reversed, then the thrust is reversed, and the aircraft moves backwards. The two airplane propellers can be turned in opposite directions of each other in order to turn the aircraft left or right in conjunction with or in place of increasing the speed of one counter rotating rotor blade over the other. In place of the two airplane propellers two small to medium size jet engines interchanged and can be used for producing even faster speeds than can be produced by the airplane propellers. There are two electronic gyroscopes located near the center of the platform that provide additional navigational and directional power for the aircraft.

On the bottom and center of the aircraft is an electric winch with a strong and flexible cable. The cable can be raised or lowered by means of an electric motor that powers the winch. Attached to the bottom of the aircraft and surrounding the winch cable is a circular telescoping extension tube that can be extended vertically. It is stationary and it can be turned to the left or right by means of an electric motor. At the end of the winch cable are two hooks that are located several inches apart and that are connected firmly to each other. A cable or telescoping extension pole can be placed across the two hooks horizontally so that the load being lifted does not spin or turn in the wind or due to the momentum of being lifted. When the circular telescoping extension tube and the horizontal cable or telescoping extension pole are used together a load being carried can be kept from spinning in the air at the end of the winch cable and can be turned left or right very easily and directed or maneuvered by the operator to the exact spot the operator desires to place the load being carried.

The fuel for the engines that powers the helicopter rotor blades is supplied by fuel pumps that pump fuel from the fuel tanks to each of the engines through strong and protected fuel tubes/lines. The fuel for the engines that power the vertical propellers is pumped by fuel pumps that pump fuel from the fuel tanks to each of the engines through strong and protected fuel tubes/lines. The electric motors and other devices on the aircraft that use electricity have the electricity supplied through cables carrying it from alternators, or other electricity producing devices, that and that are powered by engines or motors.

The aircraft is controlled by a person, or persons, who pilot(s) it from the ground using the portable remote control device that sends signals to the aircraft's devices through line of sight radio signals, infrared, or satellite relay. It is equipped with all three and can be switched between them. A human pilot can also fly or control the aircraft using the same portable control device while being carried in the human carrying attachment that attaches to the bottom of the aircraft's exoskeleton.

The aircraft will be especially useful on construction sites where it can replace large ground based cranes which are expensive, dangerous, difficult to transport, and difficult to set up. The invention can move heavy items such as steel beams, loads of lumber, equipment, and other building supplies and equipment safely and easily to very high elevations when constructing multistory buildings. The aircraft is light in weight, easy to transport, easy to set up, and can be operated by one person. It is also much less expensive to manufacture, transport, and operate than current cranes. The flying platform is very quiet when it is equipped with electric motors and does not produce any exhaust gases. In addition, an electric cable can be attached or plugged into the helicopter on one and a standard house or business/commercial electric outlet on the other end. This allows the aircraft to fly indefinitely as long as it is attached or plugged into the electric cable. While it is plugged in to the outlet the batteries onboard the aircraft are also being charged.

The aircraft can be covered on all sides with removable, protective sections that consist of screens that allow air to pass through them, but that are strong enough to protect the aircraft helicopter rotor blades and internal workings from outside objects that may run into or collide with it, or from outside objects that the aircraft may run into or collide with. These removable, protective sections completely surround the aircraft, including all of the helicopter rotor blades and all of the vertical airplane propeller blades, without significantly reducing the performance of the aircraft.

The aircraft can be attached to other aircraft of the identical design and size by use of connecting tubes or rods that are located on the top, bottom, and sides of each aircraft. These connecting tubes or rods allow electricity from all of the aircraft to be shared by all of the other aircraft that are connected together. The connecting tubes or rods allow the computers and the other devices on the aircraft to communicate and work together. The multiple aircraft can be attached together horizontally or stacked on top of the other vertically. The controls from the other aircraft can be transferred to one remote control unit. This allows one remote control unit to control all of the connected aircraft. When this is done the connected aircraft operate as one aircraft. The aircraft can be detached and separated and then operated as independent aircraft by their separate remote control unites once again.

There are electricity surge protectors and electricity surge suppression devices on board the aircraft in appropriate areas in case it is struck by lightning or accidentally comes into contact with an electric power line or other outside source of electricity. The aircraft uses material of a proper substance and design that conducts electricity from a lightning strike or from outside sources, such as an electric power line that the aircraft might accidentally come in contact with, away from the electric motors, computer system, global positioning system, and other electronic devices and either absorb or dampen the electricity or send it out of the aircraft and into the air. The removable, protective frame sections that cover and protect the entire surface of the aircraft on all sides contain a substantial of electricity insulating material that covers outside portions of them. This aids in the protection of the aircraft from damage due to being struck by lightening or by coming into contact with electric power lines or other outside sources of electricity.

There are multiple attachment hooks on the bottom of the aircraft that allow for optional attachments to be connected to the platform. These attachments allow for additional equipment and tools to be added to the aircraft in order to allow it to perform tasks other than that of being used as a flying crane. The attachments can be easily added and removed. They hook or plug directly into the aircraft's electrical system. These additional attachments will be designed and sold separately. The winch for use as a crane comes as standard equipment with the flying helicopter crane platform.

In figure or drawing number 5 an attachment is shown that is used for fighting fires in buildings. It has a water pump in the bottom to which a conventional fire hose is attached. The water is pumped up through the bottom of the firefighting attachment and out of a horizontal water spout. The water spout can be turned left or right and up or down remotely by electric motors. Through the use of cameras, microphones, and speakers located on the aircraft and on the attachment the remote operator can direct the water spout in the direction, and to the exact spot, desired. All of the engines, electric motors, equipment, other devices, and electrical wires on the aircraft are sealed appropriately so that they are water proof and can be operated in the rain without any water coming into contact with them and thus without causing damage to them or any negative effect on their operation.

In figures or drawing numbers 10 and 11 an attachment is shown that can carry multiple people. The aircraft can be remotely operated by someone on the ground while one or multiple people are flying aboard the aircraft, or someone on board the aircraft can fly it using the portable remote control unit.

The entire aircraft and its onboard machines, computers, and other items can be operated or controlled using line of site radio signals, infrared, satellite relay, or by other means. The remote control unit is portable and can be used while plugged into a standard house or business/commercial outlet or can be operated by batteries that recharge while being plugged into the standard house or business/commercial outlet. If the connection or link with the aircraft is ever lost, severed, or disrupted then the onboard aircraft computer(s) automatically take(s) control of the aircraft and goes into a hover mode for several minutes. It hovers in place where the link was lost, severed, or disrupted. If the connection or link is not reestablished within several minutes the aircraft's onboard computer and sensors automatically locate a safe place to land and lands the aircraft. The aircraft gives off or sends out a locator beacon at all times so the aircraft can easily be located or found.

The aircraft is also equipped with a series of sensors and cameras that are coordinated by a computer. If any object comes within a certain distance to the aircraft a warning alarm goes off on the aircraft and the portable remote control unit. The onboard computer then automatically takes over control of the aircraft and directs it away from the object that the computer determined the aircraft was in danger of colliding with. The computer then causes the aircraft to hover in place when it determines that the aircraft is no longer in danger of colliding with another object.

Once the computers and sensors determine that it is in a safe location it allows the human controller to take back control of the aircraft. If the computers onboard the aircraft and the remote control unit determine that there is not enough fuel or electricity left to safely operate the aircraft, or if they determine that for other reasons the aircraft cannot safely fly, an alarm will sound. If the human controller does not immediately land the aircraft then the computers will automatically take over from the human controller and will land the aircraft in a safe area. A locator beacon allows the aircraft to be located by satellite, radio signal, infrared, or other means at all times.

Not all of the items or parts are shown in each of the twelve figures or drawings are shown in every figure or drawing due to redundancy and space limitations on some of the drawings. However, all of the items or parts that appear throughout the twelve figures or drawings are part of the invention and of the flying helicopter platform or aircraft and will be built and put on the invention. The attachments can be attached and used or not used on the flying helicopter platform or aircraft as desired by the user and are also part of the invention.

### BRIEF DESCRIPTION OF THE DRAWINGS

FIG. 1. Front view facing the aircraft with the airplane propeller attachment located on top providing for extra propulsion and enhanced directional capability.

FIG. 2. Side view of two aircraft attached horizontally to each other in order to form one aircraft that can be controlled by one remote control unit.

FIG. 3. Side view of aircraft with firefighting attachment with water spout.

FIG. 4. Top view looking down onto the aircraft.

FIG. 5. Side view of the aircraft with the airplane propeller attachment located on top providing for extra propulsion and enhanced directional capability.

FIG. 6. Top view looking down onto two aircraft attached horizontally to each other in order to form one aircraft that can be controlled by one remote control unit.

FIG. 7. Side view of two aircraft attached vertically on top of each other to form one aircraft that can be controlled by one remote control unit.

FIG. 8. Side view of aircraft with the circular telescoping extension arm for stabilizing and turning loads when they are lifted. Here it is shown partially extended.

FIG. 9. Portable remote control system for operating and controlling the aircraft. It can control the aircraft, its onboard machines, equipment, computers, and other items using line of site radio signals, infrared, satellite relay, or by other means.

FIG. 10. Side view of the aircraft with the attachment for carrying one or multiple human beings.

FIG. 11. Front view of the aircraft with the attachment for carrying one or multiple human beings.

FIG. 12. Large cylinder drum around which the electric cable is wound and stored. The cylinder drum also contains a large battery which is charged when the electric cable is plugged into a standard house or business electric power outlet. This battery operates the flying helicopter crane platform's motors and other devices in case the main power source is interrupted. The cylinder drum rests on four legs that extend out form its bottom. The remote control unit can be attached to an electric power cable or chord to operate the flying helicopter crane platform remotely sending control signals through the electric wires or it can be detached and can operate the flying helicopter platform or aircraft using the radio signals, infrared, satellite relay, or other means.

### DETAILED DESCRIPTION OF THE DRAWINGS

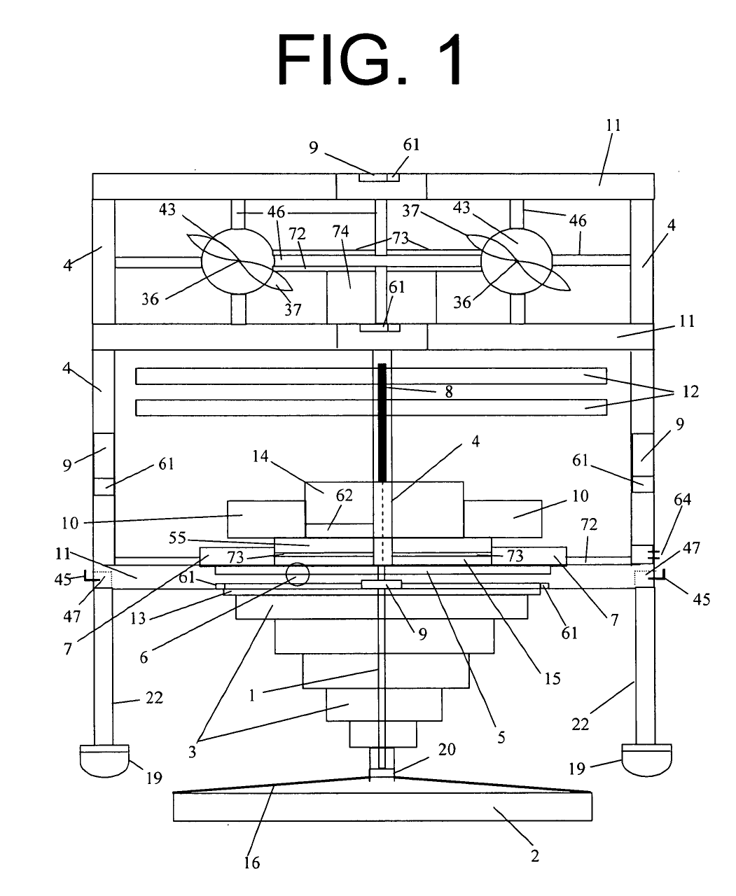

### FIG. 1

1) Winch cable for lifting loads.
2) Steel girder or beam being lifted.
3) Telescoping extension rings or arm that keeps the load being lifted or carried stationary even in strong winds. It keeps it the load from spinning or otherwise becoming unstable. It also allows the load to be turned left or right in order to maneuver or direct it where desired. In this figure it is only partially extended.
4) Connecting beams, rods, or tubes that connect top half of aircraft with bottom half of aircraft and that act as a protective exoskeleton to the aircraft. The exoskeleton protects the aircraft rotor blades from coming into contact with objects outside the aircraft.
5) Conveyer belt that heavy weight in item number 6 is attached. The conveyer belt is moved back and forth by means of an electric motor.
6) Heavy weight that is moved back and forth on the conveyer belt in item number 5. By moving the weight back and forth on the conveyer belt it shifts the weight on the aircraft from side to side or back and forth. When the weight is shifted to the left or right of the center of gravity it causes the aircraft to in one direction of the other. By doing so the counter rotating helicopter rotors also tilt along with the entire aircraft and thrust or propel the aircraft in the direction that it is tilted.
7) Liquid fuel tanks for engine version, or batteries for electric motor only version of the aircraft. These are interchangeable on each aircraft depending on whether the engines are electric motors. The liquid fuel tank or battery that goes here can be quickly and easily interchanged with each other and either the fuel lines in number 73 can be hooked up or connected or the electric wires, or power cable, or power chord in item number 72 can be connected.
8) Helicopter rotor blade shaft that the helicopter counter rotating rotor blades are attached to.
9) Video, sound gathering, microphones, speakers, and recording devices that allow that relay data to the remote control unit and allow for the video sound to be heard by the person operating the remote control unit.
10) Electronic gyroscopes that help stabilize the aircraft and help provide enhanced directional control.
11) Top and bottom circular horizontal support rings that make up the top and bottom halves of the aircraft and that act as a protective exoskeleton to the aircraft. The exoskeleton protects the aircraft rotor blades from coming into contact with objects outside the aircraft.
12) Counter rotating helicopter rotor blades.
13) Electric motor and mechanism that turns the telescoping extension rings in item number 3 to the left or right or clockwise or counterclockwise. It allows for the load to be turned left or right and therefore easily maneuvered or directed into the desired place.
14) Engines or electric motors, depending on whether it is an engine or electric motor version, that turn the counter rotating helicopter rotor blades. They can consist of one or engines or electric motors. If the multiple engine or electric motor version is used then they fit together similar to the equal parts of a pie or circle. They work in conjunction with the same gear box or transmission when there are multiple engines or electric motors used to power the counter rotating helicopter rotor blades.
15) Electric motor powered winch.
16) Strong cable made of an appropriate material for attaching to the steel girder or beam or other load being lifted and carried. Another version uses a strong telescoping and rigid pole that extends in opposite directions. This allows for the operator to turn the load left or right without it swaying back and forth due to the wind or momentum of the load being lifted and to direct it into place where desired.
19) Landing pads that attach to the end of the extension legs in item number 22 and on which the aircraft rests when not flying.
20) Two attachment hooks located at the end of the telescoping rings or arm in item number 3 and the vertical winch cable in item number 1. The horizontal cable or telescoping and rigid pole in item number 16 is attached to them. By having two attachment hooks located several inches apart the load can be kept very stable in flight when the cable or telescoping and rigid pole is attached to them.
22) Fixed landing gear legs. The landing gear legs can be detached and interchanged with other types or version of extension legs and landing gear.
36) Shaft that connects the vertical airplane propeller to the engine or electric motor.
37) Vertical airplane propeller blade for propelling the aircraft at faster speeds than the tilting of the aircraft using the weight in item numbers 5 and 6 can do. It is an add on attachment that can be added to the top or bottom of the aircraft.
43) Engine or electric motor depending, on which version is chosen. The engine and electric motors are interchangeable on each aircraft.
45) Spring loaded locking mechanism that holds extension leg in tube in item number 47 in place.
46) Tubes or rods that connect engine or electric motor to the aircraft frame.
47) Circular tube into which extension legs in item number 22 slide into or out of for attaching or detaching different versions of the extension legs.
55) Alternator for producing electricity for the aircraft.
61) Onboard sensors that can determine if the aircraft is about to collide with an object. They relay the information to the onboard computers and those on the remote control unit and they sound an alarm if they determine that the aircraft is about to collide with another object. If the sensors and computers conclude that the aircraft is about to collide with another object the computer automatically takes control of the aircraft away from the human controller and directs the aircraft to a safe location. It then hovers and allows the human controller to take back control of the aircraft when they desire to do so. If the computers onboard the aircraft and the remote control unit determine that there is not enough fuel or electricity left to safely operate the aircraft, or that there are other problems with the aircraft that don't allow it to safely fly, an alarm will sound. If the human controller does not immediately land the aircraft then the computers will automatically land the aircraft in a safe area. A locator beacon allows the aircraft to be located by satellite, radio signal, infrared, or other means at all times.
62) Computers, global positioning system, monitoring devices that monitor things such as wind speed, temperature, elevation, and things. These items are located on the aircraft.
63) Ballistic parachutes that deploy if the computers on the aircraft determine that the aircraft is descending at an unsafe speed that could cause damage to the aircraft, the load it is carrying, the onboard attachments, any people onboard the aircraft, or the any objects or area it is about to land on. These parachutes can be stored with a small amount of explosives that jettison the parachutes upward for rapid deployment in an emergency. They can also be quickly deployed using a pressurized air, or liquid device or spring loaded device that jettisons and deploys the parachutes very quickly in an emergency. The human controller or pilot can also deploy the parachutes from the remote control unit whenever desired.
64) Electric outlet for plugging in or connecting electric cable to that provides electricity from a standard house or business/commercial electric outlet. This electric cable can be securely locked in place on the aircraft and charges the aircraft's onboard batteries. If the electric cable is pulled out or becomes detached to the aircraft or there the flow of electricity through the electric cable is disrupted then the batteries onboard the aircraft can operate the entire aircraft for a significant amount of time.
72) Electric wires or electric cable that carries electricity from the batteries, alternators or other electricity generating devices, or from the electric cable or power chord and outlet in numbers 64 and 65 to all of the devices that use electricity on the aircraft.
73) Liquid fuel lines or tubes that carry liquid fuel from the fuel tank in item number 7 to the engines and all of the devices that use liquid fuel on the aircraft.
74) Liquid fuel tank or battery, depending on whether engines or electric motors are being used, for the airplane propeller engines or electric motors to use to operate. The liquid fuel tank and battery that goes here can be quickly and easily interchanged with each other and either the fuel lines in number 73 can be hooked up or connected or the electric wires, or power cable, or power chord in item number 72 can be connected.

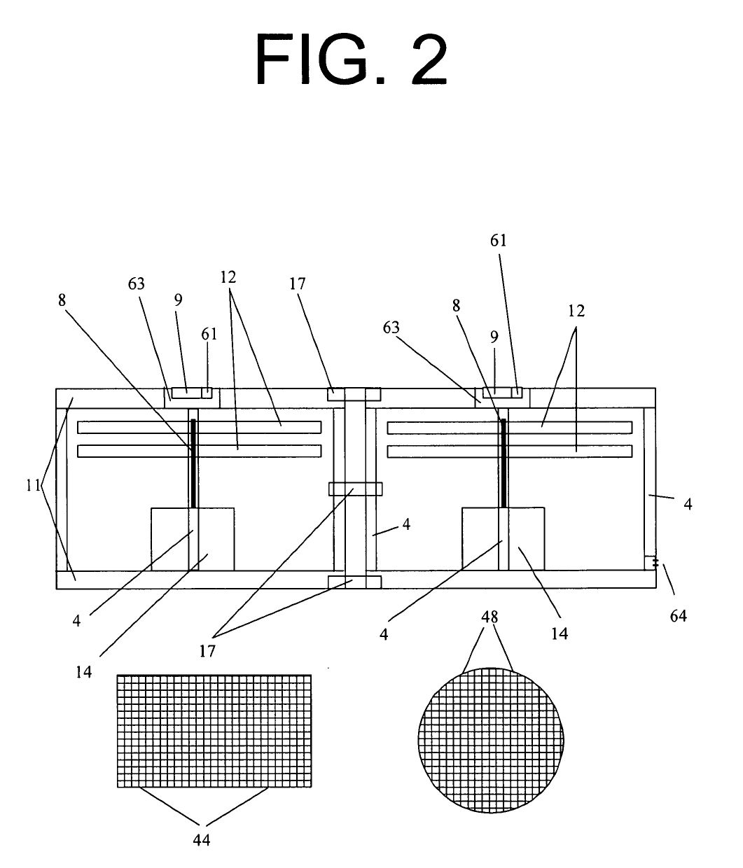

### FIG. 2

4) Connecting beams, rods, or tubes that connect top half of aircraft with bottom half of aircraft and that act as a protective exoskeleton to the aircraft. The exoskeleton protects the aircraft rotor blades from coming into contact with objects outside the aircraft.
8) Helicopter rotor blade shaft that the helicopter counter rotating rotor blades are attached to.
11) Top and bottom circular horizontal support rings that make up the top and bottom halves of the aircraft and that act as a protective exoskeleton to the aircraft. The exoskeleton protects the aircraft rotor blades from coming into contact with objects outside the aircraft.
13) Counter rotating helicopter rotor blades.
14) Engines or electric motors, depending on whether it is an engine or electric motor version, that turn counter rotating helicopter rotor blades. They can consist of one or engines or electric motors. If the multiple engine or electric motor version is used then they fit together similar to the equal parts of a pie or circle. They work in conjunction with the same gear box or transmission when there are multiple engines or electric motors used to power the counter rotating helicopter rotor blades.
17) Connecting rods or tubes that allow for two or more flying helicopter platforms or aircraft to be connected to each other and to operate as one aircraft. The electrical and computer systems connect together and act as one aircraft. The radio control, infrared, satellite, or other control system means allows two or more aircraft that are connected together to be operated by one person or controller as one flying helicopter platform or aircraft. The control is transferred from the other aircraft to one designated remote control unit. At any time the multiple aircraft can be separated and control of the various aircraft can be transferred back to each aircraft's remote control unit. The electricity is shared through the connecting rods or tubes by all of the multiple aircraft in the same amount and the onboard computers on all of the aircraft communicate and work together.
44) One of multiple flexible side panels that attach to the circular sides of the aircraft. These are porous like a screen in a door or window and allow the wind and air to blow or pass through them, but keep birds and other objects from entering into the interior of the aircraft.
48) One of two circular flexible panels that attach to the circular top and bottom of the aircraft. These are porous like a screen in a door or window and allow the wind and air to blow or pass through them, but keep birds and other objects from entering into the interior of the aircraft.
61) Onboard sensors that can determine if the aircraft is about to collide with an object. They relay the information to the onboard computers and those on the remote control unit and they sound an alarm if they determine that the aircraft is about to collide with another object. If the sensors and computers conclude that the aircraft is about to collide with another object the computer automatically takes control of the aircraft away from the human controller and directs the aircraft to a safe location. It then hovers and allows the human controller to take back control of the aircraft when they desire to do so. If the computers onboard the aircraft and the remote control unit determine that there is not enough fuel or electricity left to safely operate the aircraft, or that there are other problems with the aircraft that don't allow it to safely fly, an alarm will sound. If the human controller does not immediately land the aircraft then the computers will automatically land the aircraft in a safe area. A locator beacon allows the aircraft to be located by satellite, radio signal, infrared, or other means at all times.
63) Ballistic parachutes that deploy if the computers on the aircraft determine that the aircraft is descending at an unsafe speed that could cause damage to the aircraft, the load it is carrying, the onboard attachments, any people onboard the aircraft, or the any objects or area it is about to land on. These parachutes can be stored with a small amount of explosives that jettison the parachutes upward for rapid deployment in an emergency. They can also be quickly deployed using a pressurized air, or liquid device or spring loaded device that jettisons and deploys the parachutes very quickly in an emergency. The human controller or pilot can also deploy the parachutes from the remote control unit whenever desired.
64) Electric outlet for plugging in or connecting electric cable to that provides electricity from a standard house or business/commercial electric outlet. This electric cable can be securely locked in place on the aircraft and charges the aircraft's onboard batteries. If the electric cable is pulled out or becomes detached to the aircraft or there the flow of electricity through the electric cable is disrupted then the batteries onboard the aircraft can operate the entire aircraft for a significant amount of time.

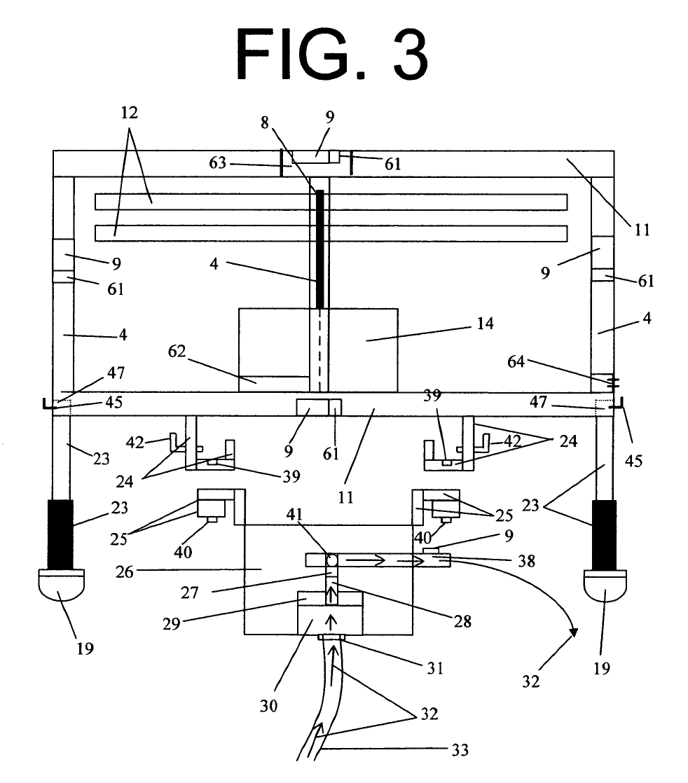

### FIG. 3

4) Connecting beams, rods, or tubes that connect top half of aircraft with bottom half of aircraft and that act as a protective exoskeleton to the aircraft. The exoskeleton protects the aircraft rotor blades from coming into contact with objects outside the aircraft.
8) Helicopter rotor blade shaft that the helicopter counter rotating rotor blades are attached to.
9) Video cameras, microphones, speakers, and sound gathering and recording devices that allows for the ground controller to see from a video screen on the remote control unit where to direct the fire hose water spout in item number 3.
11) Top and bottom circular horizontal support rings that make up the top and bottom halves of the aircraft and that act as a protective exoskeleton to the aircraft. The exoskeleton protects the aircraft rotor blades from coming into contact with objects outside the aircraft.
12) Counter rotating helicopter rotor blades.
14) Engines or electric motors, depending on whether it is an engine or electric motor version, that turn the counter rotating helicopter rotor blades. They can consist of one or engines or electric motors. If the multiple engine or electric motor version is used then they fit together similar to the equal parts of a pie or circle. They work in conjunction with the same gear box or transmission when there are multiple engines or electric motors used to power the counter rotating helicopter rotor blades.
19) Landing pads that attach to the end of the extension legs in item number 22 and on which the aircraft rests when not flying.
23) Telescoping extension legs. The extension legs can be detached and interchanged with other types or version of extension legs and landing gear.
24) Connecting mechanism on the flying helicopter platform or aircraft that allows the fire fighting and water pump attachment to be attached to the flying helicopter platform.
25) Connecting mechanisms on the bottom of the attachment that allow the fire fighting water pump and hose attachment to be attached to the flying helicopter platform.
26) Casing that surrounds firefighting water pump and hose attachment.
27) Electric motor that turns hinged swivel in item number 41 at an up or down angle so that the water spout in item number 38 can be directed up or down in order to direct the water flow as it exits the nozzle.
28) Connecting arm or rod that allows for the water spout to be turned left or right in order to direct or aim the water being sprayed on the fire.
29) Electric motor that turns connecting arm or rod in item number 28 left or right.
30) Electric pump that pumps water from the ground to the spout in item number 3. The person controlling the aircraft and the attachment can direct the water to where it is desired by using the remote control unit.
31) Mechanism that allows for a traditional or existing fire hose to be attached to the fire fighting attachment.
32) Water that flows up, through, and out the fire hose water spout on the firefighting and water pump attachment.
33) Fire hose that attaches to firefighting and water pump attachment.
38) Spout that the water flows through to be sprayed on the fire.
39) Electrical connection port, also known as the docking station, that the electrical connection in item number 40 plugs into, or fits into, so that electricity can flow from the aircraft in order to power the firefighting and water pump attachment's electrical system.
40) Electrical connection that plugs into, or fits into, the connection port in item number 39, also known as the docking station. It allows electricity to flow from the aircraft in order to power the firefighting and water pump attachment's electrical system.
41) Hinged swivel that allows for the fire hose spout in item number 3 to be maneuvered up or at a down angle.
42) Spring loaded locking mechanism that holds the firefighting and water pump attachment firmly in place to the attaching hooks in items number 24 and 25.
45) Spring loaded locking mechanism that holds extension leg in tube in item number 47 in place.
47) Circular tube into which extension legs in item number 23 slide into or out of for attaching or detaching different versions of the extension legs to the aircraft.
61) Sensors onboard the aircraft that can determine if the aircraft is about to collide with an object. They relay the information to the onboard computers and those on the remote control unit and they sound an alarm if they determine that the aircraft is about to collide with another object. If the sensors and computers conclude that the aircraft is about to collide with another object the computer automatically takes control of the aircraft away from the human controller and directs the aircraft to a safe location. It then hovers and allows the human controller to take back control of the aircraft when they desire to do so. If the computers onboard the aircraft and the remote control unit determine that there is not enough fuel or electricity left to safely operate the aircraft, or that there are other problems with the aircraft that don't allow it to safely fly, an alarm will sound. If the human controller does not immediately land the aircraft then the computers will automatically land the aircraft in a safe area. A locator beacon allows the aircraft to be located by satellite, radio signal, infrared, or other means at all times.
62) Computers, global positioning system, monitoring devices that monitor things such as wind speed, temperature, elevation, and other things. These items are located on the aircraft.
63) Ballistic parachutes that deploy if the computers on the aircraft determine that the aircraft is descending at an unsafe speed that could cause damage to the aircraft, the load it is carrying, the onboard attachments, any people onboard the aircraft, or the any objects or area it is about to land on. These parachutes can be stored with a small amount of explosives that jettison the parachutes upward for rapid deployment in an emergency. They can also be quickly deployed using a pressurized air, or liquid device or spring loaded device that jettisons and deploys the parachutes very quickly in an emergency. The human controller or pilot can also deploy the parachutes from the remote control unit whenever desired.
64) Electric outlet for plugging into, connecting, or attaching the electric cable that provides electricity from a standard house, business, or commercial electric outlet to the flying helicopter platform to operate all of its electric motors and other devices that use electricity. This electric cable can be securely locked in place on the aircraft and charges the aircraft's onboard batteries. If the electric cable is pulled out or becomes detached from the aircraft or the flow of electricity through the electric cable is disrupted then the batteries onboard the aircraft can operate the entire aircraft for a significant amount of time without the electric attached or connected to the aircraft.

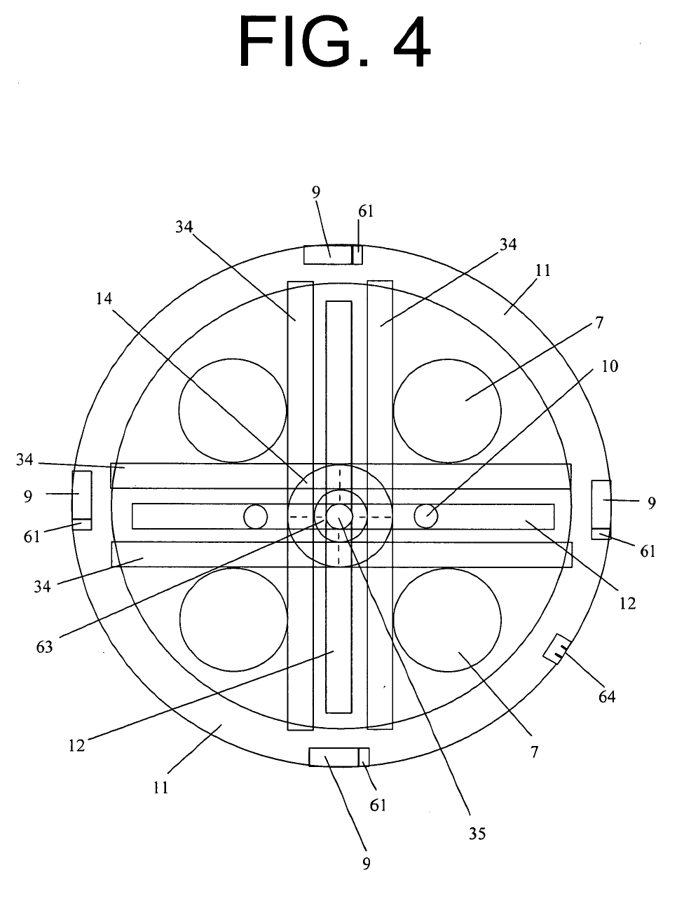

### FIG. 4

7) Liquid fuel tanks for engine version, or batteries for electric motor only version of the aircraft. These are interchangeable on each aircraft depending on whether the engines are electric motors. The engines and electric motors are also interchangeable.
9) Video, sound gathering, microphones, speakers, and recording devices that allow that relay data to the remote control unit and allow for the video sound to be heard by the person operating the remote control unit.
10) Electronic gyroscopes that help stabilize the aircraft and help provide enhanced directional control.
11) Top and bottom circular horizontal support rings that make up the top and bottom halves of the aircraft and that act as a protective exoskeleton to the aircraft. The exoskeleton protects the aircraft rotor blades from coming into contact with objects outside the aircraft.
12) Counter rotating helicopter rotor blades.
14) Engines or electric motors, depending on whether it is an engine or electric motor version, that turn the counter rotating helicopter rotor blades. They can consist of one or engines or electric motors. If the multiple engine or electric motor version is used then they fit together similar to the equal parts of a pie or circle. They work in conjunction with the same gear box or transmission when there are multiple engines or electric motors used to power the counter rotating helicopter rotor blades.
34) Horizontal support beams that connect the top and bottom rings in item number 11 and that help stabilize the upper and lower protective exoskeleton of the aircraft.
35) Rotor hub that holds that holds the counter rotating helicopter blades on the helicopter rotor blade shaft in place.
61) Onboard sensors that can determine if the aircraft is about to collide with an object. They relay the information to the onboard computers and those on the remote control system and they sound an alarm if they determine that the aircraft is about to collide with another object. If the sensors and computers conclude that the aircraft is about to collide with another object the computer automatically takes control of the aircraft away from the human controller and directs the aircraft to a safe location. It then hovers and allows the human controller to take back control of the aircraft when the person operating the remote control unit desires to do so. If the computers onboard the aircraft and the remote control unit determine that there is not enough fuel or electricity left to safely operate the aircraft, or that there are other problems with the aircraft that don't allow it to safely fly, an alarm will sound. If the human controller does not immediately land the aircraft then the aircraft's computers will automatically land the aircraft in a safe area. A locator beacon allows the aircraft to be located by satellite, radio signal, infrared, or other means at all times.
64) Electric outlet for plugging in or connecting electric cable to that provides electricity from a standard house or business/commercial electric outlet. This electric cable can be securely locked in place on the aircraft and charges the aircraft's onboard batteries. If the electric cable is pulled out or becomes detached to the aircraft or there the flow of electricity through the electric cable is disrupted then the batteries onboard the aircraft can operate the entire aircraft for a significant amount of time.

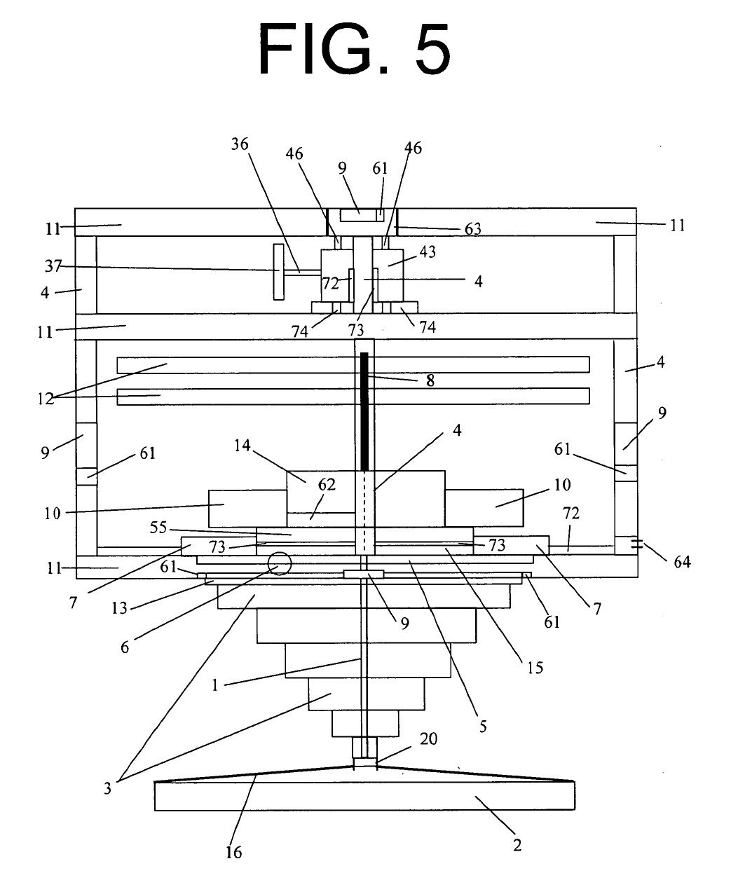

### FIG. 5

1) Winch cable for lifting loads.
2) Steel girder or beam being lifted.
3) Telescoping extension rings or arm that keeps the load being lifted or carried stationary even in strong winds. It keeps it the load from spinning or otherwise becoming unstable. It also allows the load to be turned left or right in order to maneuver or direct it where desired. In this figure it is only partially extended.
4) Connecting beams, rods, or tubes that connect top half of aircraft with bottom half of aircraft and that act as a protective exoskeleton to the aircraft. The exoskeleton protects the aircraft rotor blades from coming into contact with objects outside the aircraft.
5) Conveyer belt that heavy weight in item number 6 is attached. The conveyer belt is moved back and forth by means of an electric motor.
6) Heavy weight that is moved back and forth on the conveyer belt in item number 5. By moving the weight back and forth on the conveyer belt it shifts the weight on the aircraft from side to side or back and forth. When the weight is shifted to the left or right of the center of gravity it causes the aircraft to in one direction of the other. By doing so the counter rotating helicopter rotors also tilt along with the entire aircraft and thrust or propel the aircraft in the direction that it is tilted.
7) Liquid fuel tanks for engine version, or batteries for electric motor only version of the aircraft. These are interchangeable on each aircraft depending on whether the engines are electric motors. The liquid fuel tank or battery that goes here can be quickly and easily interchanged with each other and either the fuel lines in number 73 can be hooked up or connected or the electric wires, or power cable, or power chord in item number 72 can be connected.
8) Helicopter rotor blade shaft that the helicopter counter rotating rotor blades are attached to.
9) Video, sound gathering, microphones, speakers, and recording devices that allow that relay data to the remote control unit and allow for the video sound to be heard by the person operating the remote control unit.
10) Electronic gyroscopes that help stabilize the aircraft and help provide enhanced directional control.
11) Top and bottom circular horizontal support rings that make up the top and bottom halves of the aircraft and that act as a protective exoskeleton to the aircraft. The exoskeleton protects the aircraft rotor blades from coming into contact with objects outside the aircraft.
12) Counter rotating helicopter rotor blades.
13) Electric motor and mechanism that turns the telescoping extension rings in item number 3 to the left or right or clockwise or counterclockwise. It allows for the load to be turned left or right and therefore easily maneuvered or directed into the desired place.
14) Engines or electric motors, depending on whether it is an engine or electric motor version, that turn the counter rotating helicopter rotor blades. They can consist of one or engines or electric motors. If the multiple engine or electric motor version is used then they fit together similar to the equal parts of a pie or circle. They work in conjunction with the same gear box or transmission when there are multiple engines or electric motors used to power the counter rotating helicopter rotor blades.
15) Electric motor powered winch.
16) Strong cable made of an appropriate material for attaching to the steel girder or beam or other load being lifted and carried. Another version uses a strong telescoping and rigid pole that extends in opposite directions. This allows for the operator to turn the load left or right without it swaying back and forth due to the wind or momentum of the load being lifted and to direct it into place where desired.
20) Two attachment hooks located at the end of the telescoping rings or arm in item number 3 and the vertical winch cable in item number 1. The horizontal cable or telescoping and rigid pole in item number 16 is attached to them. By having two attachment hooks located several inches apart the load can be kept very stable in flight when the cable or telescoping and rigid pole is attached to them.
36) Horizontal shaft that connects the vertical airplane propeller to the engines or electric motors.
37) Vertical airplane propeller blade for propelling the aircraft at faster speeds than the tilting of the aircraft using the weight in item number four can do. It is an add on attachment that can be added to the top or bottom of the aircraft.
43) Engines or electric motors, depending on which version is chosen, that turns the vertical airplane propellers in item number 37. The engines and electric motors are interchangeable on each aircraft.
46) Tubes or rods that connect engine or electric motor to the aircraft frame.
55) Alternator for producing electricity for the aircraft.
61) Sensors onboard the aircraft that can determine if the aircraft is about to collide with an object. They relay the information to the onboard computers and those on the remote control system and they sound an alarm if they determine that the aircraft is about to collide with another object. If the sensors and computers conclude that the aircraft is about to collide with another object the computer automatically takes control of the aircraft away from the human controller and directs the aircraft to a safe location. It then hovers and allows the human controller to take back control of the aircraft when they desire to do so. If the computers onboard the aircraft and the remote control unit determine that there is not enough fuel or electricity left to safely operate the aircraft, or that there are other problems with the aircraft that don't allow it to safely fly, an alarm will sound. If the person controlling the aircraft using the remote control unit does not immediately land the aircraft then the computers will automatically land the aircraft in a safe area. A locator beacon allows the aircraft to be located by satellite, radio signal, infrared, or other means at all times.
62) Computers, global positioning system, monitoring devices that monitor things such as wind speed, temperature, elevation, and things. These items are located on the aircraft.
63) Ballistic parachutes that deploy if the computers on the aircraft determine that the aircraft is descending at an unsafe speed that could cause damage to the aircraft, the load it is carrying, the onboard attachments, any people onboard the aircraft, or the any objects or area it is about to land on. These parachutes can be stored with a small amount of explosives that jettison the parachutes upward for rapid deployment in an emergency. They can also be quickly deployed using a pressurized air, or liquid device or spring loaded device that jettisons and deploys the parachutes very quickly in an emergency. The human controller or pilot can also deploy the parachutes from the remote control unit whenever the person using the remote control unit desires to do so.
64) Electric outlet for plugging in or connecting electric cable to that provides electricity from a standard house or business/commercial electric outlet. This electric cable can be securely locked in place on the aircraft and charges the aircraft's onboard batteries. If the electric cable is pulled out or becomes detached to the aircraft or there the flow of electricity through the electric cable is disrupted then the batteries onboard the aircraft can operate the entire aircraft for a significant amount of time.
72) Electric wires or electric cable that carries electricity from the batteries, alternators or other electricity generating devices, or from the electric cable or power chord and outlet in numbers 64 and 65 to all of the devices that use electricity on the aircraft.
73) Liquid fuel lines or tubes that carry liquid fuel from the fuel tank in item number 7 to the engines and all of the devices that use liquid fuel on the aircraft
74) Liquid fuel tank or battery, depending on whether engines or electric motors are being used, for the airplane propeller engines or electric motors to use to operate. The liquid fuel tank and battery that goes here can be quickly and easily interchanged with each other and either the fuel lines in number 73 can be hooked up or connected or the electric wires, or power cable, or power chord in item number 72 can be connected.

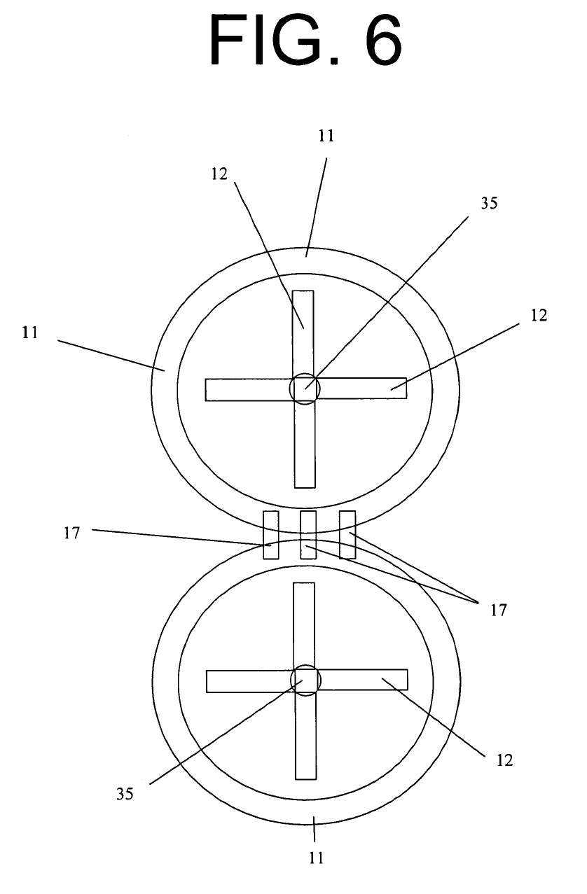

### FIG. 6

11) Top and bottom circular horizontal support rings that make up the top and bottom halves of the aircraft and that act as a protective exoskeleton to the aircraft. The exoskeleton protects the aircraft rotor blades from coming into contact with objects outside the aircraft.
12) Counter rotating helicopter rotor blades.
17) Connecting rods or tubes that allow for two or more flying helicopter platforms or aircraft to be connected to each other and to operate as one aircraft. The electrical and computer systems connect together and act as one aircraft. The radio control, infrared, satellite, or other control system means allows two or more aircraft that are connected together to be operated by one person or controller as one flying helicopter platform or aircraft. The control is transferred from the other aircraft to one designated remote control unit. At any time the multiple aircraft can be separated and control of the various aircraft can be transferred back to each aircraft's remote control unit. The electricity is shared through the connecting rods or tubes by all of the multiple aircraft in the same amount and the onboard computers on all of the aircraft communicate and work together.
35) Rotor hub that holds the counter rotating helicopter rotor blades on to the helicopter rotor blade shaft in item number 8.

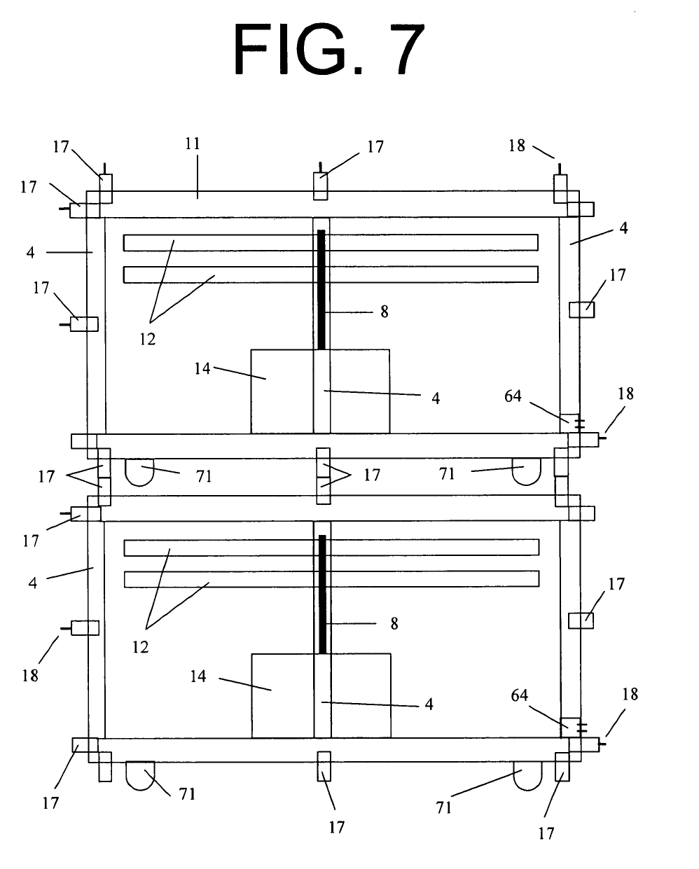

### FIG. 7

4) Connecting beams, rods, or tubes that connect top half of aircraft with bottom half of aircraft and that act as a protective exoskeleton to the aircraft. The exoskeleton protects the aircraft rotor blades from coming into contact with objects outside the aircraft.
8) Helicopter rotor blade shaft that the helicopter counter rotating rotor blades are attached to.
11) Top and bottom circular horizontal support rings that make up the top and bottom halves of the aircraft and that act as a protective exoskeleton to the aircraft. The exoskeleton protects the aircraft rotor blades from coming into contact with objects outside the aircraft.
12) Counter rotating helicopter rotor blades.
14) Engines or electric motors, depending on whether it is an engine or electric motor version, that turn the counter rotating helicopter rotor blades. They can consist of one or engines or electric motors. If the multiple engine or electric motor version is used then they fit together similar to the equal parts of a pie or circle. They work in conjunction with the same gear box or transmission when there are multiple engines or electric motors used to power the counter rotating helicopter rotor blades.
17) Connecting rods or tubes that allow for two or more flying helicopter platforms or aircraft to be connected to each other and to operate as one aircraft. The electrical and computer systems connect together and act as one aircraft. The radio control, infrared, satellite, or other control system means allows two or more aircraft that are connected together to be operated by one person or controller as one flying helicopter platform or aircraft. The control is transferred from the other aircraft to one designated remote control unit. At any time the multiple aircraft can be separated and control of the various aircraft can be transferred back to each aircraft's remote control unit. The electricity is shared through the connecting rods or tubes by all of the multiple aircraft in the same amount and the onboard computers on all of the aircraft communicate and work together.
18) Insert rods at the tip of some of the connecting rods or tubes in item number 17. These allow for the electricity on each aircraft to be shared among all of the multiple aircrafts items and equipment that use electricity. It also allows for the computers and other equipment that uses electricity to share information or data and to work together.
64) Electric outlet for plugging in or connecting electric cable to that provides electricity from a standard house or business/commercial electric outlet. This electric cable can be securely locked in place on the aircraft and charges the aircraft's onboard batteries. If the electric cable is pulled out or becomes detached to the aircraft or there the flow of electricity through the electric cable is disrupted then the batteries onboard the aircraft can operate the entire aircraft for a significant amount of time.
71) Alternate type of landing pads that can be attached to the bottom of the flying helicopter platform or aircraft. These do not contain extension legs and cannot be extended, but are very lightweight and can be easily attached to numerous desired areas on the bottom of the aircraft in a short period of time.

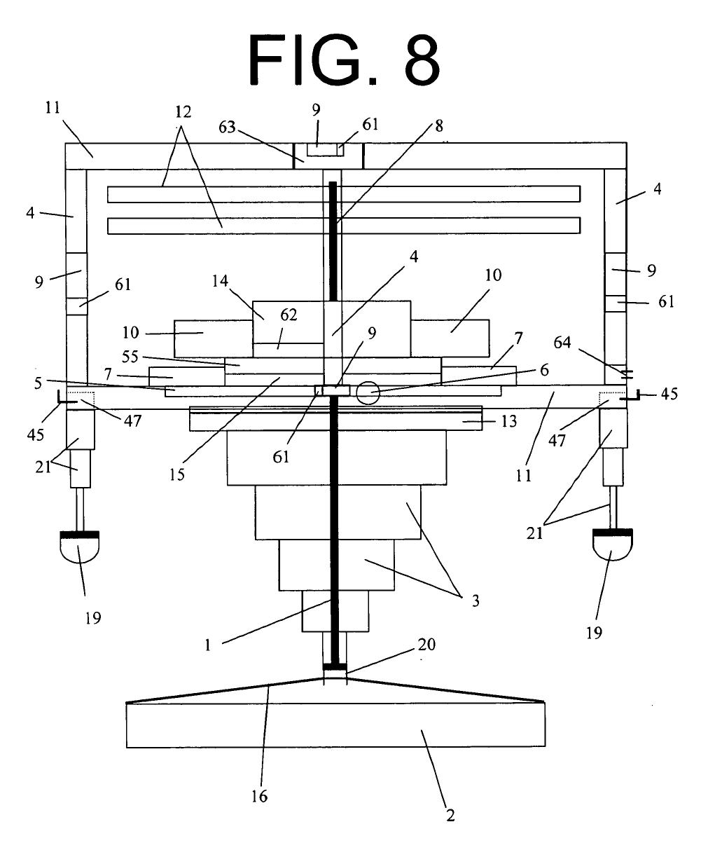

### FIG. 8

1) Winch cable for lifting loads.
2) Steel girder or beam being lifted.
3) Telescoping extension rings or arm that keeps the load being lifted or carried stationary even in strong winds. It keeps it the load from spinning or otherwise becoming unstable. It also allows the load to be turned left or right in order to maneuver or direct it where desired. In this figure it is only partially extended.
4) Connecting beams, rods, or tubes that connect top half of aircraft with bottom half of aircraft and that act as a protective exoskeleton to the aircraft. The exoskeleton protects the aircraft rotor blades from coming into contact with objects outside the aircraft.
5) Conveyer belt that heavy weight in item number 6 is attached. The conveyer belt is moved back and forth by means of an electric motor.
6) Heavy weight that is moved back and forth on the conveyer belt in item number 5. By moving the weight back and forth on the conveyer belt it shifts the weight on the aircraft from side to side or back and forth. When the weight is shifted to the left or right of the center of gravity it causes the aircraft to in one direction of the other. By doing so the counter rotating helicopter rotors also tilt along with the entire aircraft and thrust or propel the aircraft in the direction that it is tilted.
7) Liquid fuel tanks for engine version, or batteries for electric motor only version of the aircraft. These are interchangeable on each aircraft depending on whether the engines are electric motors. The engines and electric motors are also interchangeable.
8) Helicopter rotor blade shaft that the helicopter counter rotating rotor blades are attached to.
9) Video, sound gathering, microphones, speakers, and recording devices that allow that relay data to the remote control unit and allow for the video sound to be heard by the person operating the remote control unit.
10) Electronic gyroscopes that help stabilize the aircraft and help provide enhanced directional control.
11) Top and bottom circular horizontal support rings that make up the top and bottom halves of the aircraft and that act as a protective exoskeleton to the aircraft. The exoskeleton protects the aircraft rotor blades from coming into contact with objects outside the aircraft
12) Counter rotating helicopter rotor blades.
13) Electric motor and mechanism that turns the telescoping extension rings in item number 3 to the left or right or clockwise or counterclockwise. It allows for the load to be turned left or right and therefore easily maneuvered or directed into the desired place.
14) Engines or electric motors, depending on whether it is an engine or electric motor version, that turn the counter rotating helicopter rotor blades. They can consist of one or engines or electric motors. If the multiple engine or electric motor version is used then they fit together similar to the equal parts of a pie or circle. They work in conjunction with the same gear box or transmission when there are multiple engines or electric motors used to power the counter rotating helicopter rotor blades.
15) Electric motor powered winch.
16) Strong cable made of an appropriate material for attaching to the steel girder or beam or other load being lifted and carried. Another version uses a strong telescoping and rigid pole that extends in opposite directions. This allows for the operator to turn the load left or right without it swaying back and forth due to the wind or momentum of the load being lifted and to direct it into place where desired.
19) Landing pads that attach to the end of the extension legs in item number 22 and on which the aircraft rests when not flying.
20) Two attachment hooks located at the end of the telescoping rings or arm in item number 3 and the vertical winch cable in item number 1. The horizontal cable or telescoping and rigid pole in item number 16 is attached to them. By having two attachment hooks located several inches apart the load can be kept very stable in flight when the cable or telescoping and rigid pole is attached to them.
21) Telescoping extension legs that can be extended to a desired length or retracted. The extension legs can be detached and interchanged with other types or version of extension legs and landing gear.
45) Spring loaded locking mechanism that holds extension leg in tube in item number 47 in place.
47) Circular tube into which extension legs in item number 21 slide into or out of for attaching or detaching different versions of the extension legs.
55) Alternators for producing electricity for the aircraft.
61) Sensors onboard the aircraft that can determine if the aircraft is about to collide with an object. They relay the information to the onboard computers and those on the remote control system and they sound an alarm if they determine that the aircraft is about to collide with another object. If the sensors and computers conclude that the aircraft is about to collide with another object the computer automatically takes control of the aircraft away from the human controller and directs the aircraft to a safe location. It then hovers and allows the human controller to take back control of the aircraft when they desire to do so. If the computers onboard the aircraft and the remote control unit determine that there is not enough fuel or electricity left to safely operate the aircraft, or that there are other problems with the aircraft that don't allow it to safely fly, an alarm will sound. If the person controlling the aircraft using the remote control unit does not immediately land the aircraft then the computers will automatically land the aircraft in a safe area. A locator beacon allows the aircraft to be located by satellite, radio signal, infrared, or other means at all times.
62) Computers, global positioning system, monitoring devices that monitor things such as wind speed, temperature, elevation, and things. These items are located on the aircraft.
64) Electric outlet for plugging in or connecting electric cable to that provides electricity from a standard house or business/commercial electric outlet. This electric cable can be securely locked in place on the aircraft and charges the aircraft's onboard batteries. If the electric cable is pulled out or becomes detached to the aircraft or there the flow of electricity through the electric cable is disrupted then the batteries onboard the aircraft can operate the entire aircraft for a significant amount of time.

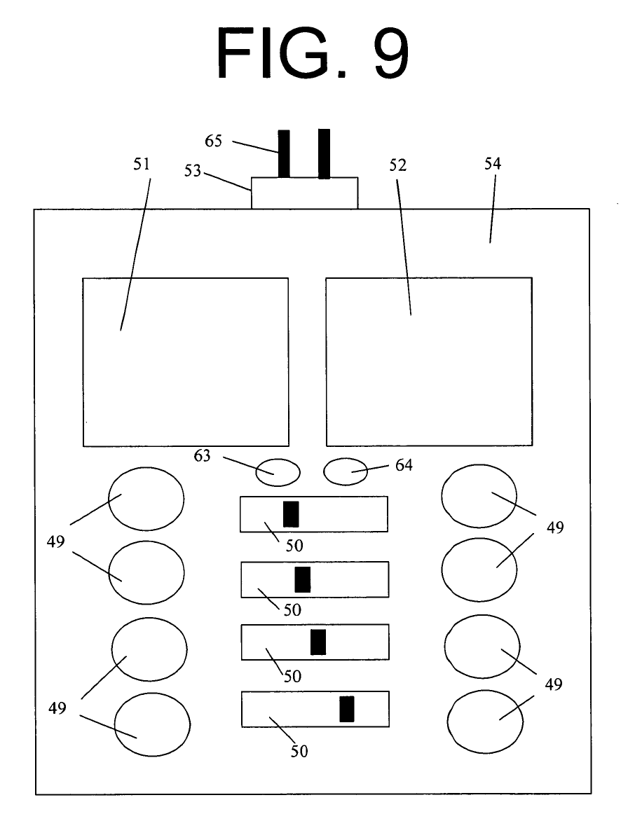

### FIG. 9

49) Devices on remote control unit that allow the operator to control the aircraft and all of the devices on the aircraft. The aircraft can be controlled by line of sight radio signals, infrared, or satellite relay, or by other means. The operator can choose whichever mode that the operator desires. All of the controls can be operated by physically touching them or by moving them by hand, or they can be controlled by voice command. A computer can receive voice commands and can then execute or carry them out.
50) Devices on remote control unit that allow the operator to control the aircraft and all of the devices on the aircraft. The aircraft can be controlled by line of sight radio signals, infrared, or satellite relay, or by other means. The operator can choose whichever mode that the operator desires. All of the controls can be operated by physically touching them or by moving them by hand, or they can be controlled by voice command. A computer can receive voice commands and can then execute or carry them out.
51) Global Positioning System video touch screen. This allows the operator to enter the exact location where the operator wants the aircraft to go. Once the desired location is entered the aircraft can fly on computer operated auto pilot to the exact location and either hovers in the air or lands automatically. The computers will automatically select the optimal speed, best route, elevation, and other necessary things that will allow the aircraft to arrive in the quickest and safest way. The operator can choose to operate every aspect of flying the aircraft manually or only choose to operate certain functions of flying the aircraft manually and let the computers operate the rest of them. The operator can also let the computer completely operate the aircraft using a computer auto pilot system. At any time the operator can take control back over from the computers.
   These computers are located both on board the aircraft and in the remote control unit. The touch screen also acts as the computer screen that allows the operator to input data such as the distance desired to be traveled, the weight desired to be lifted, and the amount of time in flight that is desired. The computer touch screen can be switched or designated between the global positioning screen and the computer touch screens. The computer will automatically calculate the amount of fuel or battery power needed. The computer screen provides the current weight of the aircraft and the wind speed around it. The computer software allows the operator to input specific scenarios before engaging in a flying activity in order to see what the probable results will be. For example, the operator can enter data showing a steel beam of a certain size or dimensions being lifted to 100 feet, of a certain weight, and with a certain wind speed, or even certain wind gusts. The computer modeling software will then show what the probable results would be even before the operator engaged in the activity. If the wind gusts at the speed entered would cause a 10 foot sway in the beam and would be unsafe then that would be shown on the screen. This helps that operator know either how to compensate for the wind speed or if it is unsafe to fly the aircraft at that moment with that type of load.
   The operator can switch back and forth between the global positioning screen and the computer screens. All of the data that is input or that is automatically gathered is saved on the computer hard drive and can be retrieved in the future if desired. It can also be transmitted to other computers anywhere in the world in real time and saved on their hard drives if this is desired. This allows anyone who is given access anywhere in the world to monitor and see the exact things that the operator is seeing on the remote control unit screens as long as the computer they are on has the correct computer software and connection devices.
   This can be done using direct contact to the device by satellite relay, infrared, radio signals, cellular phone signals, internet, or by other means. By using touch screen technology or icons, icons that can be clicked by using a computer mouse, or by using a keyboard, anyone who has the correct computer software loaded on their computer and who has the correct username(s) and password(s), can be given the ability to operate the aircraft from anywhere in the world from any computer, including laptops, and hand held personal computers such as Blackberry hand held computers, Palm Pilots, Apple iPhones, and many others. The security system will be very secure to ensure that only someone authorized can access the aircraft controls or can monitor what is being seen on the remote control unit's screen. This feature can be turned on or off or can be locked by someone with administrative rights. It can also be turned on for one aircraft and not for others in the case of an individual, organization, or company owning multiple aircraft.
   If the connection or link with the aircraft is ever lost, severed, or disrupted then the onboard aircraft computer automatically takes control of the aircraft and goes into a hover mode for several minutes. It hovers in place where the link was lost, severed, or disrupted or it the computers and sensors determine that it is not a safe place to hover, if locates a safe place to hover and moves to that spot and hovers. If the connection or link is not reestablished within several minutes the aircraft's onboard computers and sensors automatically locate a safe place to land and lands the aircraft. The aircraft gives off or sends out a locator beacon so the aircraft can easily be located or found at all times.
   The aircraft is equipped with a series of sensors and cameras that are coordinated by computers. If any object comes within a certain distance of the aircraft a warning alarm goes off on the aircraft and the portable remote control unit. The onboard computers then automatically take over control of the aircraft and direct it away from the object that the computers determined the aircraft was in danger of colliding with. The computers then cause the aircraft to hover in place when it determines that it is no longer in danger of colliding with another object and then allows the human controller of the aircraft to take back control of the aircraft when desired. If the computers onboard the aircraft and the remote control unit determine that there is not enough fuel or electricity left to safely operate the aircraft, or if they determine that for other reasons the aircraft cannot safely fly, an alarm will sound. If the human controller does not immediately land the aircraft then the computers will take over control of the aircraft from the human controller and will automatically land the aircraft in a safe area. A locator beacon is sent out from the aircraft at all times and allows the aircraft to be located by satellite, radio signal, infrared, and other means at all times.
52) Video screen that allows for the operator, or anyone who is anywhere in the world on any computer with the correct software and connection devices, including laptops, and hand held personal computers such as Blackberry hand held computers, Palm Pilots, Apple iPhones, and many others, to see and hear what the many video cameras and microphones on the aircraft see and here. All of this data is automatically recorded in the remote control unit and can also be sent to other computers anywhere in the world to be recorded. The recording function can be turned off if that is desired for any specific recording device or for all of them.
53) Mechanism that allows for the electric cable or power chord to be attached or detached from the remote control unit in item number 54.
54) Portable remote control unit that allows a person to control and operate the aircraft and all of its onboard machines, engines, electric motors, and other devices. All of the controls can be operated by physically touching them or by moving them by hand, or they can be controlled by voice command. A computer can receive voice commands and can then execute or carry them out. It has a durable, strong and lightweight casing that surrounds and contains the many mechanisms, video screens, and computers and other devices on the portable remote control unit. The aircraft can be flown by a person on board with this attachment or someone on the ground can fly the aircraft while one multiple people are on board the aircraft.
63) Microphone on remote control unit that allows the human controller to talk to people onboard the aircraft when it has the attachment carrying humans on board. It also allows the human controller to talk to people near the aircraft even when the attachment that carries people is not on board. The aircraft also has microphones onboard that allow the person operating the remote control unit to hear sounds onboard or near the aircraft and to talk to people onboard or near the aircraft.
64) Speaker that allows the human controller to hear sounds on board the aircraft and to hear people talk to him who are onboard the aircraft when the human attachment is being used, or to hear and talk to people who are near the aircraft when there is no human attachment being used.
65) Electric power chord that provides power to the remote control device and recharges the remote control device's batteries so that it can be disconnected from the electric power chord and it can then be operated by battery only power until the batteries need to be recharged again.

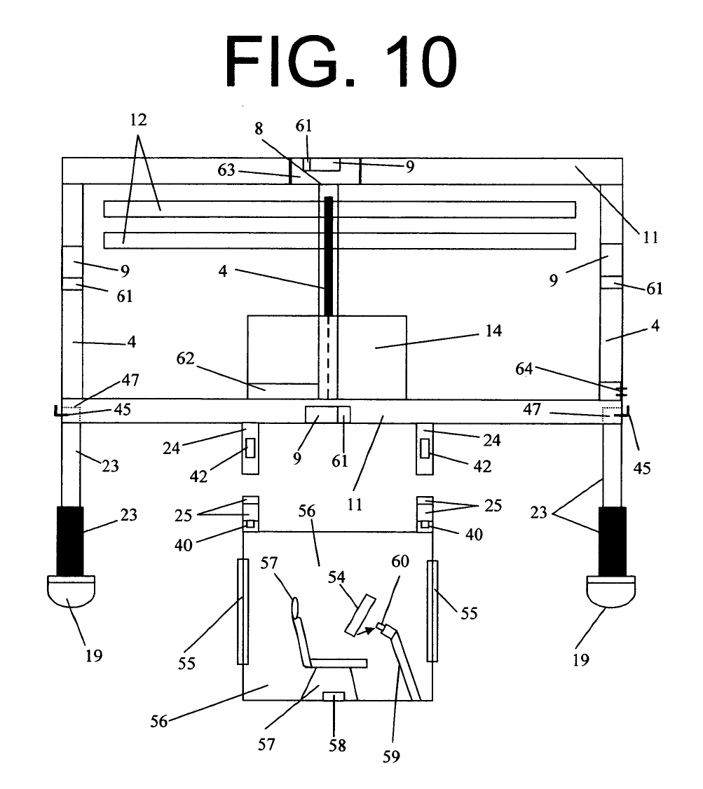

### FIG. 10

4) Connecting beams, rods, or tubes that connect top half of aircraft with bottom half of aircraft and that act as a protective exoskeleton to the aircraft. The exoskeleton protects the aircraft rotor blades from coming into contact with objects outside the aircraft.
8) Helicopter rotor blade shaft that the helicopter counter rotating rotor blades are attached to.
9) Video, sound gathering, microphones, speakers, and recording devices that allow that relay data to the remote control unit and allow for the video sound to be heard by the person operating the remote control unit.
11) Top and bottom circular horizontal support rings that make up the top and bottom halves of the aircraft and that act as a protective exoskeleton to the aircraft. The exoskeleton protects the aircraft rotor blades from coming into contact with objects outside the aircraft.
14) Engines or electric motors, depending on whether it is an engine or electric motor version, that turn the counter rotating helicopter rotor blades. They can consist of one or engines or electric motors. If the multiple engine or electric motor version is used then they fit together similar to the equal parts of a pie or circle. They work in conjunction with the same gear box or transmission when there are multiple engines or electric motors used to power the counter rotating helicopter rotor blades.
19) Landing pads that attach to the end of the extension legs in item number 23 and on which the aircraft rests when not flying.
23) Telescoping extension legs. The extension legs can be detached and interchanged with other types or versions of extension legs and landing gear.
24) Connecting mechanism on flying helicopter platform or aircraft that allows the fire fighting water pump attachment to be attached to the flying helicopter platform.
25) Connecting mechanism on fire fighting water pulp attachment that allows the attachment to be attached to the flying helicopter platform.
39) Electrical connection port, also known as the docking station, that the electrical connection in item number 40 plugs into, or fits into, so that electricity can flow from the aircraft to the attachment in order to power the attachment's electrical system.
40) Electrical connection that plugs into, or fits into, the connection port in item number 39, also known as the docking station. It allows electricity to flow from the aircraft to the attachment in order to power the attachment's electrical system.
42) Spring loaded locking mechanism the holds the attachment firmly in place with the attaching mechanisms or hooks in items number 24 and 25.
45) Spring loaded locking mechanism that holds extension leg in tube in item number 47 in place.
47) Circular tube into which extension legs in item number 23 slide into or out of for attaching or detaching different versions of the extension legs for landing the aircraft on.
54) Portable remote control unit that allows a person to control and operate the aircraft and all of its onboard machines, engines, electric motors, and other devices. All of the controls can be operated by physically touching them or by moving them by hand, or they can be controlled by voice command. A computer can receive voice commands and can then execute or carry them out. It has a durable, strong and lightweight casing that surrounds and contains the many mechanisms, video screens, and computers and other devices on the portable remote control unit. The aircraft can be flown by a person on board with this attachment or someone on the ground can fly the aircraft while one multiple people are on board the aircraft.
55) Windows on attachment. The attachment can carry two human beings and has windows on all four sides and other appropriate areas.
56) Side view of compartment that attaches to the bottom of the aircraft. It can carry multiple human beings comfortably. It contains multiple chairs for people to sit in. One of the chairs sits in front of the remote control unit when the remote control unit is locked or set in place. This allows the person sitting in from of the remote control unit to operate the entire aircraft and to operate the machines, computers, and equipment onboard the aircraft and on the attachment. The remote control unit can be removed and carried with a person so that the person can control the aircraft and the attachment remotely when the controller or pilot is not physically located onboard the aircraft. In this way the aircraft can be controlled remotely by anyone anywhere in the world as an unmanned aerial vehicle (UAV) or the aircraft can be controlled by a person onboard the aircraft using this attachment.
57) Side view of the chairs with adjustable head rests that people onboard the attachment to the aircraft sit in.
58) Video camera, microphone, and speakers for gathering video, sounds, and for talking back and forth to the controller or pilot or anyone in the world who has the correct computer software loaded on their computer and who has the correct usernames and passwords to gain access. These relay the video and sounds below and around the aircraft to the remote controller in item number 54 so that the person controlling the aircraft (the onboard pilot) can see what is below and around the aircraft in order to help the onboard controller or pilot better control and fly the aircraft.
59) Adjustable stand that the remote controller in item number 54 attaches to. It holds the remote control unit in place while the person is onboard and flying the aircraft so that it is in a stable location for the person to operate, fly, or control the aircraft.
60) Connecting rod, tube, or mechanism that protrudes from the remote control stand in item number 59. It allows for the remote control unit to firmly attach to the stand in item number 59. It also has an electric power supply that plugs into the remote control unit when it is attached to it and the stand that supplies electricity to, and provides electric power to, the remote control unit. It also recharges the remote control unit's batteries at the same time.
61) Sensors onboard the aircraft that can determine if the aircraft is about to collide with an object. They relay the information to the onboard computers and those on the remote control system and they sound an alarm if they determine that the aircraft is about to collide with another object. If the sensors and computers conclude that the aircraft is about to collide with another object the computer automatically takes control of the aircraft away from the human controller and directs the aircraft to a safe location. It then hovers and allows the human controller to take back control of the aircraft when they desire to do so. If the computers onboard the aircraft and the remote control unit determine that there is not enough fuel or electricity left to safely operate the aircraft, or that there are other problems with the aircraft that don't allow it to safely fly, an alarm will sound. If the person controlling the aircraft using the remote control unit does not immediately land the aircraft then the computers will automatically land the aircraft in a safe area. A locator beacon allows the aircraft to be located by satellite, radio signal, infrared, or other means at all times.
62) Computers, global positioning system, monitoring devices that monitor things such as wind speed, temperature, elevation, and things. These items are located on the aircraft.
64) Electric outlet for plugging in or connecting electric cable to that provides electricity from a standard house or business/commercial electric outlet. This electric cable can be securely locked in place on the aircraft and charges the aircraft's onboard batteries. If the electric cable is pulled out or becomes detached to the aircraft or there the flow of electricity through the electric cable is disrupted then the batteries onboard the aircraft can operate the entire aircraft for a significant amount of time.

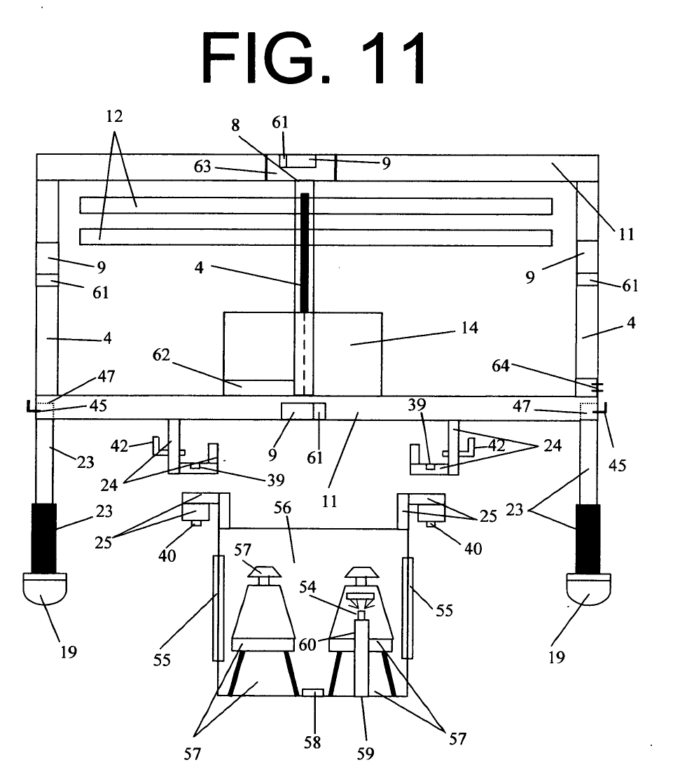

### FIG. 11

4) Connecting beams, rods, or tubes that connect top half of aircraft with bottom half of aircraft and that act as a protective exoskeleton to the aircraft. The exoskeleton protects the aircraft rotor blades from coming into contact with objects outside the aircraft.
8) Helicopter rotor blade shaft that the helicopter counter rotating rotor blades are attached to.
9) Video, sound gathering, microphones, speakers, and recording devices that allow that relay data to the remote control unit and allow for the video sound to be heard by the person operating the remote control unit.
11) Top and bottom circular horizontal support rings that make up the top and bottom halves of the aircraft and that act as a protective exoskeleton to the aircraft. The exoskeleton protects the aircraft rotor blades from coming into contact with objects outside the aircraft.
14) Engines or electric motors, depending on whether it is an engine or electric motor version, that turn the counter rotating helicopter rotor blades. They can consist of one or engines or electric motors. If the multiple engine or electric motor version is used then they fit together similar to the equal parts of a pie or circle. They work in conjunction with the same gear box or transmission when there are multiple engines or electric motors used to power the counter rotating helicopter rotor blades.
19) Landing pads that attach to the end of the telescoping extension legs in item number 23 and on which the aircraft rests when not flying.
23) Telescoping extension legs. The extension legs can be detached and interchanged with other types or versions of extension legs and landing gear.
24) Connecting mechanism on flying helicopter platform or aircraft that allows the fire fighting water pump attachment to be attached to the flying helicopter platform.
25) Connecting mechanism on fire fighting water pulp attachment that allows the attachment to be attached to the flying helicopter platform.
39) Electrical connection port, also known as the docking station, that the electrical connection in item number 40 plugs into, or fits into, so that electricity can flow from the aircraft to the attachment in order to power the attachment's electrical system.
40) Electrical connection that plugs into, or fits into, the connection port in item number 39, also known as the docking station. It allows electricity to flow from the aircraft to the attachment in order to power the attachment's electrical system.
42) Spring loaded locking mechanism the holds the attachment firmly in place with the attaching mechanisms or hooks in items number 24 and 25.
45) Spring loaded locking mechanism that holds extension leg in tube in item number 47 in place.
47) Circular tube into which extension legs in item number 23 slide into or out of for attaching or detaching different versions of the extension legs for landing the aircraft on.
54) Portable remote control unit that allows a person to control and operate the aircraft and all of its onboard machines, engines, electric motors, and other devices. All of the controls can be operated by physically touching them or by moving them by hand, or they can be controlled by voice command. A computer can receive voice commands and can then execute or carry them out. It has a durable, strong and lightweight casing that surrounds and contains the many mechanisms, video screens, and computers and other devices on the portable remote control unit. The aircraft can be flown by a person on board with this attachment or someone on the ground can fly the aircraft while one multiple people are on board the aircraft.
55) Windows on attachment. The attachment can carry two human beings and has windows on all four sides and other appropriate areas.
56) Side view of compartment that attaches to the bottom of the aircraft. It can carry multiple human beings comfortably. It contains multiple chairs for people to sit in. One of the chairs sits in front of the remote control unit when the remote control unit is locked or set in place. This allows the person sitting in from of the remote control unit to operate the entire aircraft and to operate the machines, computers, and equipment onboard the aircraft and on the attachment. The remote control unit can be removed and carried with a person so that the person can control the aircraft and the attachment remotely when the controller or pilot is not physically located onboard the aircraft. In this way the aircraft can be controlled remotely by anyone anywhere in the world as an unmanned aerial vehicle (UAV) or the aircraft can be controlled by a person onboard the aircraft using this attachment.
57) Front view of the chairs with adjustable head rests that people onboard the attachment to the aircraft sit in.
58) Video camera, microphone, and speakers for gathering video, sounds, and for talking back and forth to the controller or pilot or anyone in the world who has the correct computer software loaded on their computer and who has the correct usernames and passwords to gain access. These relay the video and sounds below and around the aircraft to the remote controller in item number 54 so that the person controlling the aircraft (the onboard pilot) can see what is below and around the aircraft in order to help the onboard controller or pilot better control and fly the aircraft.
59) Adjustable stand that the remote controller in item number 54 attaches to. It holds the remote control unit in place while the person is onboard and flying the aircraft so that it is in a stable location for the person to operate, fly, or control the aircraft.
60) Connecting rod, tube, or mechanism that protrudes from the remote control stand in item number 59. It allows for the remote control unit to firmly attach to the stand in item number 59. It also has an electric power supply that plugs into the remote control unit when it is attached to it and the stand that supplies electricity to, and provides electric power to, the remote control unit. It also recharges the remote control unit's batteries at the same time.
61) Sensors onboard the aircraft that can determine if the aircraft is about to collide with an object. They relay the information to the onboard computers and those on the remote control system and they sound an alarm if they determine that the aircraft is about to collide with another object. If the sensors and computers conclude that the aircraft is about to collide with another object the computer automatically takes control of the aircraft away from the human controller and directs the aircraft to a safe location. It then hovers and allows the human controller to take back control of the aircraft when they desire to do so. If the computers onboard the aircraft and the remote control unit determine that there is not enough fuel or electricity left to safely operate the aircraft, or that there are other problems with the aircraft that don't allow it to safely fly, an alarm will sound. If the person controlling the aircraft using the remote control unit does not immediately land the aircraft then the computers will automatically land the aircraft in a safe area. A locator beacon allows the aircraft to be located by satellite, radio signal, infrared, or other means at all times.
62) Computers, global positioning system, monitoring devices that monitor things such as wind speed, temperature, elevation, and things. These items are located on the aircraft.
64) Electric outlet for plugging in or connecting electric cable to that provides electricity from a standard house or business/commercial electric outlet. This electric cable can be securely locked in place on the aircraft and charges the aircraft's onboard batteries. If the electric cable is pulled out or becomes detached to the aircraft or there the flow of electricity through the electric cable is disrupted then the batteries onboard the aircraft can operate the entire aircraft for a significant amount of time.

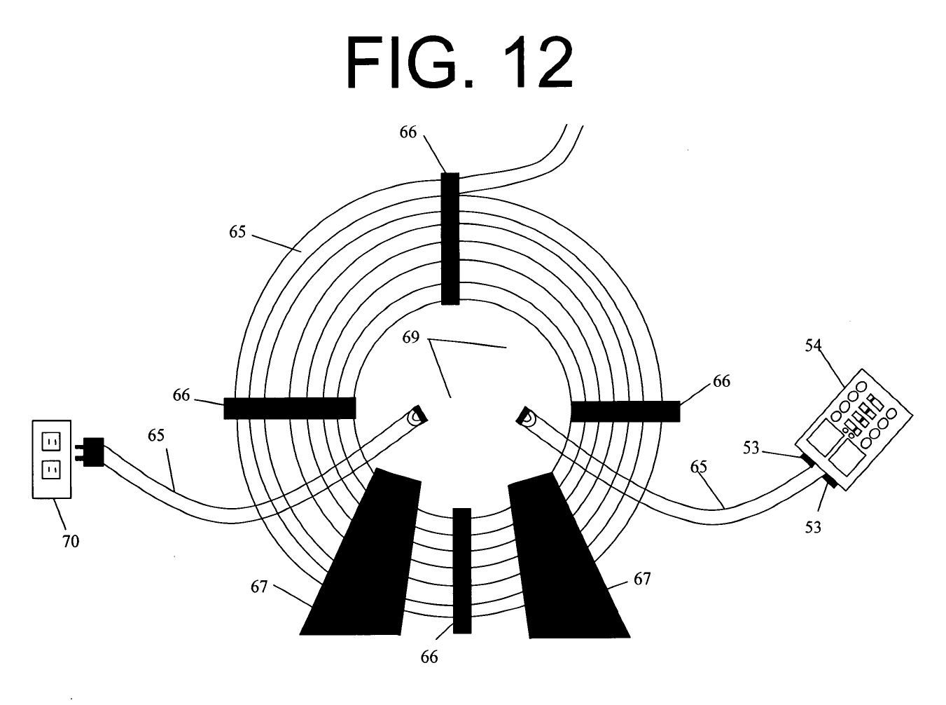

### FIG. 12

53) Mechanism that allows for the electric cable or power chord to be attached or detached from the remote control unit in item number 54.
54) Portable remote control unit that allows a person to control and operate the aircraft and all of its onboard machines, engines, electric motors, and other devices. All of the controls can be operated by physically touching them or by moving them by hand, or they can be controlled by voice command. A computer can receive voice commands and can then execute or carry them out. It has a durable, strong and lightweight casing that surrounds and contains the many mechanisms, video screens, and computers and other devices on the portable remote control unit. The aircraft can be flown by a person physically on board the attachment using the remote control unit or someone on the ground can fly the aircraft while one or multiple people are onboard the aircraft
65) Electric cable or power chord that plugs into, attaches to, or connects to the flying helicopter platform or aircraft's electric power cable outlet in item number 64. The electric cable provides electricity from a standard house, business, or commercial electric outlet to the flying helicopter platform to operate all of its electric motors and other devices that use electricity. This electric cable can be securely locked in place on the aircraft and charges the aircraft's onboard batteries while attached while at the same time supplying electricity to operate the entire aircraft. If the electric cable is pulled out, becomes unplugged, or becomes detached from the aircraft or the flow of electricity through the electric cable is disrupted in any way, then the batteries onboard the aircraft can operate the entire aircraft for a significant amount of time without the electric attached or connected to the aircraft. Alternators and other electricity producing devices are also onboard the aircraft and produce electricity to operate the aircraft and recharge its onboard batteries.
66) Strong rigid, rectangular, strips or straps that are longer on two sides and are connected by strips at the ends to form a rectangle. These four sided rectangular strips with 90 degree angles are attached to the circular drum that holds the electrical cable. These rectangular strips or straps hold the electrical cable in place while it is coiled or wrapped on the drum in item number 69 similar to a those on a circular drum holding a coiled water garden hose in place.
67) Strong and firm base legs or stand that the cylinder drum in item number 69 rests or is stored on.
68) Strong and firm holding clamps that allows the electrical cable in item number 65 to be detached and reattached easily to the cylinder drum in item number 69.
69) Circular drum that the electric power cable or chord is coiled, wound, or wrapped around and stored on. It is similar to the circular drum that holds a coiled water garden hose in place. The circular drum also contains a battery that is charged whenever the electrical cable or power chord in item number 3 is plugged into a standard house, business, or commercial electric power outlet. This battery automatically supplies temporary power to the flying platform's electrically operated devices if the power from the electrical cable plugged into the standard house, building, or commercial electric power outlet is disconnected or the power is otherwise interrupted.
70) Standard electric house, business, or commercial electric power outlet that the electric cable or power chord in item number 65 can plug or connect to in order to supply electric power to the flying helicopter platform or aircraft.

What is claimed is:

1. An exoskeleton apparatus that surrounds the outer perimeter of the helicopter aircraft platform on all sides, including the rotor blades; it is strong and lightweight and provides protection for the helicopter aircraft platform and prevents or reduces damage to the helicopter aircraft platform in case it comes into contact with an outside object; it is attached to the bottom of the helicopter aircraft platform's electric motors or internal combustion engines by bolts, screws, glue, epoxy or other appropriate means.

2. The exoskeleton apparatus as recited in claim 1, wherein the exoskeleton is made of tubes and columns that are close enough together to provide the stability and strength needed to protect the helicopter aircraft platform, but that are far enough apart to allow a sufficient amount of air to flow around them for the helicopter rotor blades to operate.

3. The exoskeleton apparatus as recited in claim 1, further comprising of attachable and detachable porous panels that can be added or removed from the sides, top, and bottom of the exoskeleton; these panels act as screens that have large enough pours to allow a sufficient amount of air to flow around them for the helicopter rotor blades to operate, but that are close enough together to keep put things such as birds or other objects that could damage the helicopter aircraft platform if they were to come into contact with any of its parts; they are attached to exoskeleton by means of bolts or screws that hold them in place.

4. The exoskeleton apparatus as recited in claim 1, further comprising of an interlocking system of two or more tubes and latches, as is needed, in multiple different groups, each located on the outward facing side of the exoskeleton on the sides, on the top, and on the bottom; the tubes face outward and allow multiple exoskeletons, and thus helicopter aircraft platform, to be attached to each other by vertically stacking them on top of each other or attaching them horizontally to each other in different patterns; this allows for the two or more helicopter aircraft platform to be attached or interlocked with each other and thus be operated as one helicopter aircraft platform aircraft providing great lifting and carrying power.

5. The exoskeleton apparatus as recited in claim 1, further comprising an attachment receiving and holding apparatus located on the bottom side of the exoskeleton consisting of hook like holding cradles to which attachments of various types and capabilities or uses can be attached or connected to the bottom of the exoskeleton and thus be carried with the helicopter aircraft platform to which the exoskeleton is attached.

6. The exoskeleton apparatus as recited in claim 1, further comprising of a horizontal propulsion attachment that attaches to the top of the exoskeleton and that contains either one or more horizontal airplane propellers that are turned by either electric motors or fuel powered internal combustion engines; the horizontal propulsion attachment can be used to propel the helicopter aircraft platform forward at greater speeds than could be achieved without it or it can help slow the helicopter aircraft platform down by reversing the direction of the rotation of the airplane propellers; the horizontal propulsion attachment attaches or is fixed firmly to the top of the exoskeleton by the use of multiple bolts or screws.

7. A telescoping arm attachment apparatus that can be attached to or removed from the bottom of the exoskeleton recited in claim 1 by means of the attachment receiving and holding apparatus recited in claim 5; the telescoping arm apparatus runs vertically and can extend and retract by use of interlocking telescoping hollow tubes that are lowered or raised by use of an electric winch and cable; each consecutive section is a little smaller than the one above it which allows each section to fit firmly into the section above it when the telescoping arm is raised; the electric motor turns a drum that the cable is attached to and the cable is wound up or coiled around the drum as it turns; this raises or lowers the telescoping arm depending on which direction the motor turns; the electric motor turns a series of gears that result in a large amount of weight being able to be raised or lowered as the drum is turned and the winch cable is raised or lowered; the cable runs or travels through the center of the hollow telescoping tubes and attaches to either to a horizontal bar connecting the attachment hooks located at the lower end of the last or lowest telescoping hollow tube or to a horizontal rod that runs across the bottom center of the last bottom or lowest tube section to which it is attached.

8. The telescoping arm attachment as recited in claim 7, further comprises a horizontal rod that extends a short distance past the bottom edge of the last or lowest tube section and fits into angled slits that it slides into when the winch is raised; there are two circular discs that are attached to each end of the horizontal rod and that run perpendicular to it; these keep the horizontal rod from moving past the edges of the last or lowest tube section; attached to this rod are either one or two hooks or other attachment apparatus, as needed, that a load or other item can be attached to in order to be raised, lifted, lowered, or set down.

9. The telescoping arm attachment as recited in claim 7, further comprises an electric motor that turns a series of gears that are attached to the upper most section of the vertical telescoping arm and that turn the vertical telescoping arm left, right, clockwise, or counter clockwise; this causes the load attached to the end of the hooks or other attachment apparatus, as recited in claim 8, to be turned left, right, clockwise, or counter clockwise.

10. The telescoping arm attachment as recited in claim 7, further comprises a set of guiding grooves located on the inside of each section of the vertical telescoping arm; the outside of each section of the vertical telescoping arm has a raised or protruding section that fits into the inside of the groove in the next section; this causes the next lower section to turn left, right, clockwise, or counter clockwise, when the tube above it is turned.

11. The telescoping arm attachment as recited in claim 7, further comprises a protruding horizontal edge or lip that extends inward at the lowest end of each of the telescoping tube sections; further, there is a horizontal lip or edge that protrudes outward at the highest or upper end of each telescoping section; when the telescoping arm is extended and these two edges come into contact with each other it prevents the telescoping tube sections from moving completely past each other and prevents the telescoping arm from coming apart.

12. A human carrying transport attachment that can be attached to or removed from the bottom of the exoskeleton by means of the attachment receiving and holding apparatus recited in claim 5; the human carrying transport attachment can carry one or more human beings and allows for a human being to operate or pilot the helicopter aircraft platform by using a remote hand held control device that operates the helicopter aircraft platform using radio, infrared, or satellite signals.

13. The human carrying transport attachment recited in claim 12, further comprises a compartment that is enclosed on all sides with front, side, and rear windows for viewing.

14. The human carrying transport attachment recited in claim 12, further comprises a global positioning system and computer integrated system that can fly the helicopter aircraft platform automatically when the location or desired instructions are entered into the computer system or someone located on the ground can fly it remotely or a human being located in the human carrying transport attachment can operate or pilot the helicopter aircraft platform by use of the hand held control unit using radio, infrared, or satellite control signals.

15. A fire fighting water hose attachment that can be attached to or removed from the bottom of the exoskeleton by means of the attachment receiving and holding apparatus recited in claim 5; it comprises a partially enclosed compartment that provides a horizontal platform to which a water hose spout is attached.

16. The fire fighting water hose attachment cited in claim 15, further comprising of a water hose spout that is attached to a ball and socket joint that allows it to turn 360 degrees and tilt upward or down; it can be turned and tilted remotely by use of electric motors that are controlled by a human operator located on the ground.

17. The fire fighting water hose attachment cited in claim 15, further comprising of a water tank and pump that enables the water to be pumped out of the water house spout with enough force to spray a significant distance in order to put out a fire.

18. The fire fighting water hose attachment cited in claim 15, further has an apparatus that allows for a fire hose on the ground to be attached to the fire hose spout so that a steady flow of water can be provided from the a fire hydrant, fire truck, or other means.

19. The fire fighting water hose attachment cited in claim 15, further comprising of multiple video cameras, microphones, and speakers whose video and sound is remotely conveyed to the hand held remote control system so the operator on the ground can view where to spray the water and can hear and talk back to any people in the vicinity of the helicopter aircraft platform.

20. A navigation apparatus for helicopter aircraft platform that enables it to travel or move in different directions or to hover in place.

21. The navigation apparatus as recited in claim 20, wherein a horizontal conveyer belt runs from one side of the bottom of the helicopter aircraft platform to the other side in a straight line and is turned by an electric motor.

22. The navigation apparatus as recited in claim 20, further has a weight securely attached to the bottom of the conveyer belt; the weight is moved from one side of the bottom of the helicopter aircraft platform or to the other as the conveyer belt moves; as the weight moves it shifts the center of gravity and thus causes the helicopter aircraft, along with its rotors to tilt in the direction of the weight's movement and fly in that direction; when the weight is moved directly to the center of gravity of the helicopter aircraft platform then the helicopter aircraft platform hovers; when the helicopter aircraft platform rotates the convey belt and the weight attached to it rotate and cause the helicopter aircraft platform to move in whichever direction the side where the weight is currently located is pointed at that moment since that is the direction the helicopter aircraft platform is tilted towards.
